(19) United States
(12) Patent Application Publication
(10) Pub. No.: US 2016/0277283 A1
(43) Pub. Date: Sep. 22, 2016

(54) CALCULATING A SHORTEST PATH FIRST TREE

(71) Applicant: HANGZHOU H3C TECHNOLOGIES CO., LTD, Hangzhou City, Zhejiang (CN)

(72) Inventor: Zhiming HUANG, Beijing (CN)

(73) Assignee: Hangzhou H3c Technologies Co., Ltd, Hangzhou City (CN)

(21) Appl. No.: 15/031,166

(22) PCT Filed: Oct. 28, 2014
(86) PCT No.: PCT/CN2014/089722

§ 371 Date: Apr. 21, 2016

(30) Foreign Application Priority Data
Oct. 28, 2013 (CN) 2013 10516437.6

(51) Int. Cl. H04L 12/721; H04L 12/751

(52) U.S. Cl. CPC H04L 45/124; H04L 45/026

(57) ABSTRACT

A method is described in which a first shortest path bridging (SPB) node and a neighboring second SPB node are connected via n links; a plurality of different neighborhoods are established between the first node and the second SPB node; and a shortest path first (SPF) tree is calculated in accordance with the links with the same cost.

### BACKGROUND

Shortest path bridging (SPB), specified in IEEE 802.1aq, is a replacement for the older Spanning Tree Protocols (IEEE 802.1D STP, IEEE 802.1w RSTP, IEEE 802.1s MSTP) which permit only a single path toward the root bridge and block any redundant paths which could result in a layer-2 loop. SPB technology allows all paths to be active with multiple equal cost paths (ECTs). In data plane, packets may be encapsulated at the edge bridge in mac-in-mac (defined in 802.1ah). The control plane of SPB technology is based on IS-IS with a small number of extensions (called SPB IS-IS) defined in RFC 6329.

### BRIEF DESCRIPTION OF THE DRAWINGS

FIG. 1 is a block diagram of an example SPB node.

FIG. 2 is an example flowchart of the SPB forwarding path control method.

FIG. 3 is an example schematic view illustrating the multiple links between two nodes within a SPB network.

FIG. 4 is an example flowchart illustrating a SPB node connected with other SPB node by multiple links.

FIG. 5 is an example schematic view illustrating the SPB network of FIG. 3 in detail.

FIG. 6 is an example SPB network topology depicted by a link state database (LSDB) of different SPB nodes.

FIG. 7 is a schematic view illustrating load balance effect achieved by different forwarding paths.

### DETAILED DESCRIPTION

After the connection between two SPB nodes are established, the SPB nodes may exchange Hello messages to discover opposite nodes and establish a neighbor logic link with the opposite node. The neighborhoods between the SPB nodes own an attribute named “cost.” The shortest path relates to a path between two SPB nodes with minimum cost among a plurality of links. In order to obtain the shortest path between two nodes, SPB nodes encapsulate link state information (LSI) within the Link State Protocol (LSP) message spreading to the SPB nodes with neighborhood. Each SPB node obtain the link states and the network topology via collecting the LSI within the LSP message from neighboring SPB nodes. Also, the shortest paths from a specific SPB node to other SPB nodes are also calculated. A set of the shortest paths depicts a shortest path first (SPF) tree. When paths with the same cost and hops exist between two SPB nodes, the paths are deemed as equivalent paths, which may contribute to load balance. The load balance may be achieved by equal cost tree (ECT) algorithm. By adopting the SPF tree and the ECT algorithm, each SPB node may calculate the shortest forwarding path so as to generate corresponding entries for forwarding the data packets from users.

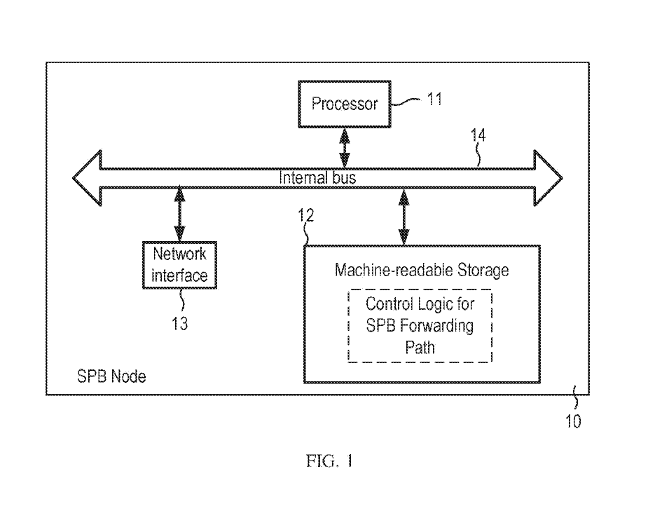

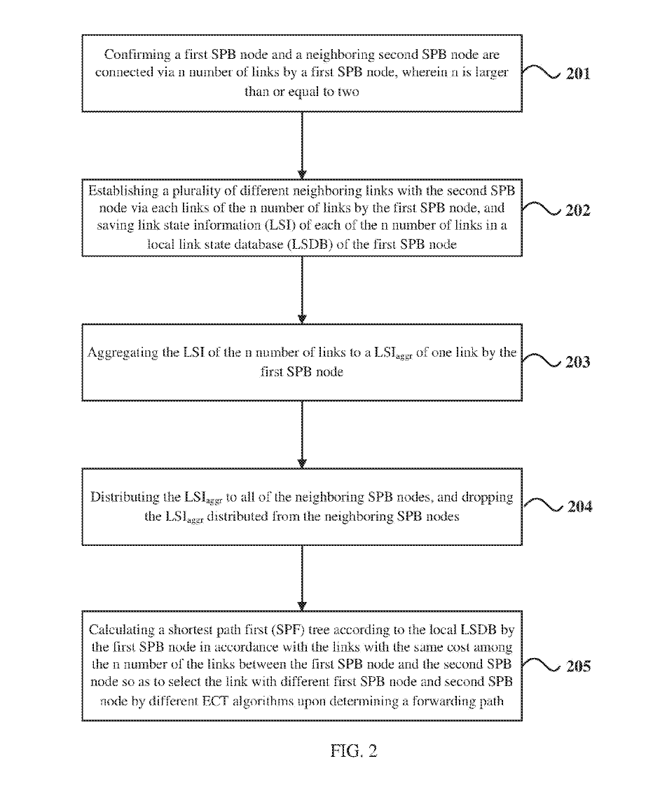

In an example, a forwarding path control logic operating on the SPB nodes may be accomplished by utilizing idle links so as to enhance the performance of load balance. Each SPB node may adopt the SPB forwarding path control logic. Referring to FIG. 1, a SPB node 10 includes a processor 11, a machine-readable storage 12, and a network interface 113. All of the above-mentioned components are connected by a bus 14. Referring to FIG. 2, in this example, the processor 11 reads the forwarding path control logic of a first SPB node from machine-readable storage 12. The process will be described hereinafter.

At block 201, the first SPB node determines that the first SPB node and a neighboring second SPB node are connected by n links, wherein n is larger than or equal to 2.

At block 202, the first SPB node establishes n different neighborhoods between the first SPB node and the second SPB node through the n links. The LSI of each of the n links are saved in a local LSDB of the first SPB node.

At block 203, the first SPB node may aggregate the LSIs of the n links to an aggregated LSI (LSI_{aggr}).

At block 204, the first SPB node may distribute the LSI_{aggr} to all of the neighboring SPB nodes, and may drop the LSI_{aggr} distributed from the neighboring SPB nodes.

At block 205, the first SPB node calculates the SPF tree according to the local LSDB, in which the cost of each link of the n links used for calculating is same, whereby to the first SPB node could select different links between first SPB node and second SPB node by different ECT algorithms upon determining the forwarding path.

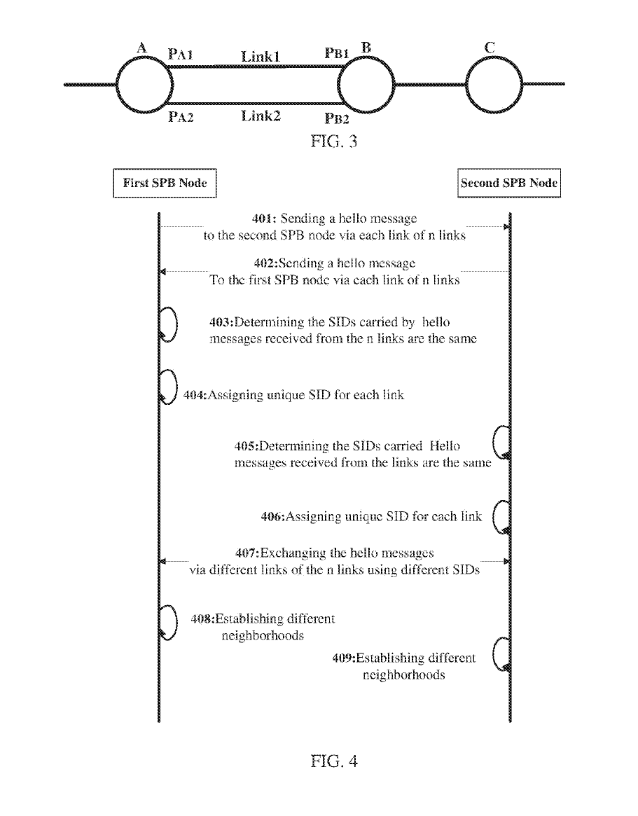

Referring to FIGS. 2 and 3, in an example, the first SPB node and the second SPB node are respectively denoted as node A and B in FIG. 3. Node A and B execute the above SPB forwarding path control logic. Assuming node A and B are connected via Link1 and Link2, that is, n equals to 2. Node A assigns a unique system-ID (SID) respectively for Link1 and link2. That is, a first SID and a second SID are assigned for Link1 and Link2. The Hello message sent from node A to node B via Link1 carries the first SID, and the Hello message sent from node A to node B via Link2 carries the second SID. Node B may execute similar process. As different SIDs are adopted, there may be two neighborhoods established by different SIDs between node A and B. Such process may be compatible with SPB ISIS protocol.

In an example, the plurality of links between node A and node B are predetermined by configuration information designated by an administrator. The administrator may distribute configuration information toward node A. the configuration information for the links may indicate that ports PA1 and PA2 of node A respectively connects to the same SPB node (node B) via Link1 and Link2. After saving the configuration information, node A may determine that there are multiple links connect to node B accordingly. Similarly, the administrator may distribute the configuration information toward node B.

The first SPB node sends the Hello message to the second SPB node via different links using different SIDs, and the second SPB node sends the Hello message to the first SPB node via different links using different SIDs. There are different neighborhoods exist between the first SPB node and the second SPB node.

In another example, the first SPB node and the second SPB node, such as node A and B, may adopt an automatic discovery process to determine whether the two nodes are connected by a plurality of links and to automatically configure the SIDs so as to establish different neighborhoods. Referring to FIG. 4, the automatic discovery process includes the following blocks.

At block 401, the first SPB node sends a hello message to the second SPB node via each link of n links.

At block 402, the second SPB node sends a hello message to the first SPB node via each link of n links.

At block 403, the first SPB node may determine the SIDs carried by the Hello messages received from the n links are same.

At block 404, the first SPB node assigns a unique SID for each link respectively.

At block 405, the second SPB node determines the SIDs carried by the Hello messages received from the n links are same.

At block 406, the second SPB node assigns a unique SID for each link respectively.

At block 407, the first SPB node sends the Hello massage to the second SPB node via different links of the n links using different SIDs. The second SPB node sends the Hello massage to the first SPB node via different links of the n links using different SIDs.

At block 408, the first SPB node establishes n different neighborhoods with the second SPB node.

At block 409, the second SPB node establishes n different neighborhoods with the first SPB node.

In view of the above blocks 401-409, it can be understood that node A and node B are not aware of being connected via the multiple links when the connection is initially established. Thus, node A and B may carry the same SID when sending the Hello massage to each other. Node A and B may be aware of the multiple links upon respectively receiving the Hello messages carrying the same SID via two links.

Node A may automatically assign two different SIDs, i.e., the first SID and the second SID, after determining that node A is connected with node B via 2 links. In other examples, different SIDs may be configured manually by the administrator in advance. The length of the SID may be 48 bits. In an example, node A may first configure the 44 lower-bits, and may set the 4 higher-bits as zero. That is, the SID of node A may be in the form of: “0xxx-xxxx-xxxx (in Hex).” Upon determining there are multiple links between node A and node B, node A may configure two different SIDs, such as “0aaa-aaaa-aaaa” and “1aaa-aaaa-aaaa”. It can be seen that the lower-bits of the SIDs are the same, and the higher-bits of the SIDs are different.

After configuring the two different SIDs, node A may adopt the first SID and the second SID for sending the Hello message respectively via the 2 links, such as Link1 and Link2. For instance, the SID “0aaa-aaaa-aaa” is carried when the Hello message is sent via Link1, and the SID “1aaa-aaaa-aaa” is carried when the Hello message is sent via Link2. Node B may have similar process. For instance, the SID “0bbb-bbbb-bbbb” is carried when the Hello message is sent via Link1, and the SID “1bbb-bbbb-bbbb” is carried when the Hello message is sent via Link2.

After the plurality of neighborhoods are established between node A and node B, two entries may be added into a neighbor table of node A, as shown in Table 1. “Adjacent SID” denotes the SID of the neighboring node, i.e., node B. “Local Circuit ID” denotes the ID of a local port. For example, PA1 represents the local port connecting to Link1. “Adjacent Circuit ID” denotes the port ID of the opposite end, i.e., node B. For example, PB1 represents the port ID of the opposite end of Link1. The cost may be calculated by parameters such as a bandwidth of the link. Generally, a smaller cost represents a better link quality. The same rule is adopted to calculate the cost for each SPB node within the SPB network. Thus, the cost for Link1 calculated by node A and node B equal to 10.

TABLE 1

| | Local Circuit | Adjacent Circuit | |
|---|---|---|---|
| Adjacent SID | ID | ID | Link Cost |
| 0bbb-bbbb-bbbb | P_{A1} | P_{B1} | 10 |
| 1bbb-bbbb-bbbb | P_{A2} | P_{B2} | 15 |

In an example, after the neighborhoods with node B are established, node A may not directly distribute the corresponding LSI. For instance, node A may not distribute the LSI of Link1 and Link2 to other neighboring SPB nodes. Node A may distribute a LSI_{aggr} relating to a Link_{aggr} that does not physically exists. The cost of the Link_{aggr} is calculated in accordance with the cost of Link1 and Link2. Before the LSI_{aggr} is distributed by node A, the nodes may calculate Cost_{aggr} of the Link_{aggr}. In an example, Cost_{aggr} is calculated by the equation below:

Cost_{aggr}=1/(1/Cost_{L1}+1/Cost_{L2});

In Table 1, Cost_{aggr} and Cost_{L2} are respectively 10 and 15. In this example, the Cost_{aggr} equals to 6 after the calculation.

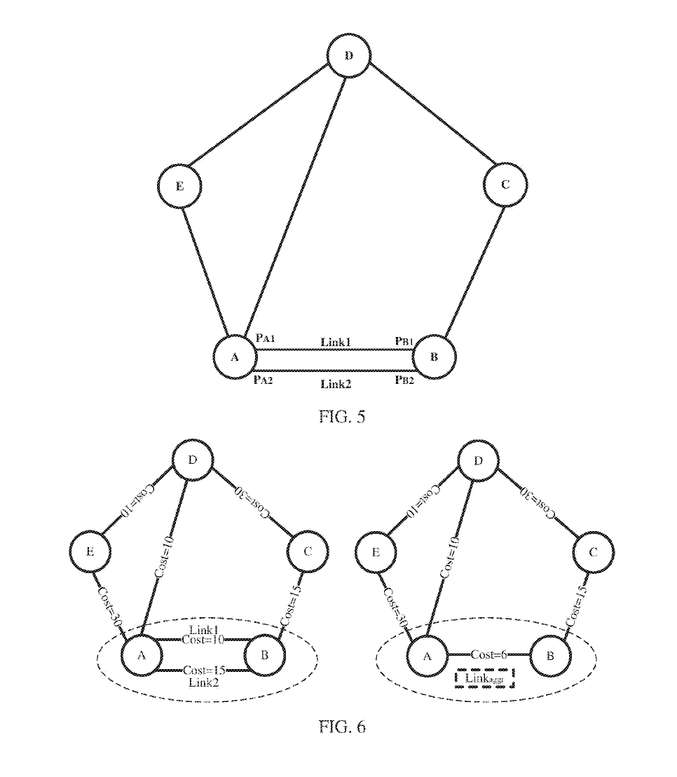

Referring to FIG. 5, after obtaining the Cost_{aggr}, node A may distribute the LSI_{aggr}. In an example, the LSI message distributed from node A to other nodes may carry the LSI_{aggr}. The LSI_{aggr} may include SID, Adjacent SID, and Cost_{aggr}. It can be understood that LSI may include other information. Comparing to the above-mentioned process regarding the establishment of neighborhoods, the SID carried by each LSI are the same when each LSI, including the LSI_{aggr}, is distributed by node A. For instance, the SID may be “0aaa-aaaa-aaa” so as to avoid the confusion for other SPB nodes. When the LSI_{aggr} is distributed from node A to node E via LSP message, node E may analyze the LSP message to obtain the LSI_{aggr}. Afterward, node E may add the entries in the LSDB as listed in Table 2 as an example. By analyzing the LSI_{aggr}, node E may be aware of that the cost of the Linkaggr between node A with SID “0aaa-aaaa-aaa” and node B with SID “0bbb-bbbb-bbb” equals to 6. Node E may then distribute the LSI_{aggr} to node D. Node D may execute similar process.

TABLE 2

| SID | SID | Link Cost |
|---|---|---|
| 0aaa-aaaa-aaa | 0bbb-bbbb-bbbb | 6 |

Similarly, node A may distribute the LSI_{aggr} to node B. As node B executes the SPB forwarding path control logic with node A, node B may generate the same LSI_{aggr} by aggregating Link1 and Link2. Thus, node B discards the LSI_{aggr} without saving the LSI_{aggr} to the LSDB after node B receives the LSI_{aggr} distributed by node A. In an example, node A or node B may save identifiers of the LSI_{aggr} in an exceptional list. Upon receiving the LSI distributed from one neighboring SPB node, the LSI identifier is compared with the exceptional list. The LSI may be dropped when the LSI identifier has matched one of the exceptional list. In an example, the LSI_{aggr} identifier may be an identifier set of the SPB nodes arranged at two opposite ends of the link. For instance, the identifier set may be a combination of the “0aaa-aaaa-aaaa” and the “0bbb-bbbb-bbbb” as shown in Table 2. Similarly, node B may distribute the same LSI_{aggr} to node A, and then the LSI_{aggr} is discarded without being saved to the LSDB of node A.

Unlike node A and node B, other nodes may save the LSI_{aggr} to its own LSDB. Each LSDB may describe the SPB network topology. As shown in FIG. 5, node A and node B have its own understanding regarding the topology between node A and node B according to its own LSDB, which can be seen in Tables. 3 and 4.

TABLE 3

| No. | SID | SID | Link Cost |
|---|---|---|---|
| 1 | 0aaa-aaaa-aaaa | 0bbb-bbbb-bbbb | 10 |
| 2 | 1aaa-aaaa-aaaa | 1bbb-bbbb-bbbb | 15 |
| 3 | 0ccc-cccc-cccc | 0ddd-dddd-dddd | 20 |
| . . . | . . . | . . . | . . . |

TABLE 4

| No. | SID | SID | Link Cost |
|---|---|---|---|
| 1 | 0aaa-aaaa-aaaa | 0bbb-bbbb-bbbb | 6 |
| 3 | 0ccc-cccc-cccc | 0ddd-dddd-dddd | 20 |
| . . . | . . . | . . . | . . . |

Table. 3 is an example LSDB of node A, which describes the LSI of Link1 and Link2 between node A and node B. Link1 and Link2 are links that physically exist. Also referring to Table. 4, the link state information of the Link_{aggr} between node A and node B is also described in the LSDB of node E. The Link_{aggr} is a link that does not physically exist. But node E may deem the Link_{aggr} as a link physically exists due to the LSP messages distributed by node A. This means that the SPB network topology depicted by the LSDB of node A is different from the SPB network topology depicted by the LSDB of node E, which may be referenced respectively by the left-side and right-side network topology of FIG. 6.

The SPB nodes distribute the LSP to synchronize the LSDB. Afterward, each SPB node may calculate the SPF tree in accordance with the local LSDB. For a node with a plurality of neighborhoods, the SPF tree is calculated by first checking whether the costs for the neighborhoods are the same. If the costs for the neighborhoods are not the same, before block 205 is executed, node A may configure the cost of Link1 and Link2 to be the same. For instance, the cost of Link1 and Link2 are configured to be 12, and then the SPF tree is calculated. In an example, the cost of Link1 and Link2 saved in the LSDB of node A are different. Thus, upon calculating the SPF tree, the cost of Link1 and Link2 are read from the LSDB, and then the cost of Link1 and Link2 are configured to be the same. Afterward, the process continues to calculate the SPF tree. In another example, node A may save the cost of Link1 and Link2 to the LSDB with an average number, such as 12. In this way, the values of the cost may be directly read from the LSDB without further configuration.

SPB nodes may be configured with a plurality of ECT algorithms, i.e., 16 ECT algorithms. Each ECT algorithm correspond to one or multiple virtual service instances (VSIs). The ECT algorithms may select one path among a plurality of paths with the same cost as the forwarding path. For any two nodes of the SPF tree, different ECT algorithm may be selected for the SPF tree. When paths with the same cost exist between two nodes, a different forwarding path may be selected for the corresponding VSI.

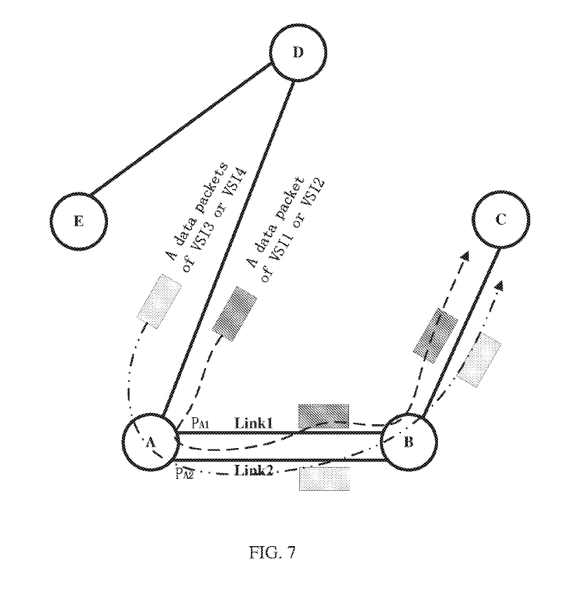

FIG. 7 shows an example SPF tree calculated by node A. Referring to table 5, in this example, the ECT algorithm “X” is selected for VSI1 and VSI2. The forwarding path from node A to node C is: A→B(link1)→C, which means PA1 is selected as an egress port. When the ECT algorithm “Y” is selected for VSI3 and VSI4, the forwarding path from node A to node C is: A→B(link2)→C, which means PA2 is selected as an egress port. After the forwarding paths are calculated, a corresponding forwarding table for each VSI is generated (see Table. 4). When node A receives a data message destined to node C, the corresponding port is PA1 by querying the forwarding table of VSI if the VSI identifier carried by the data message is VSI1 or VSI2. That is, the data message destined to node C is forwarded via Link1. Similarly, when node A receives the data message destined to node C, the corresponding port is PA2 by querying the forwarding table of VSI if the VSI identifier carried by the data message is VSI3 or VSI4. That is, the data message destined to node C is forwarded via Link2.

FIG. 5

| VSI | | | |
|---|---|---|---|
| identifier | Destination's MAC | Next-hop | Egress Port |
| VSI1 | MAC address of node C | Node B | PA1 |
| VSI 2 | MAC address of node C | Node B | PA1 |
| VSI 3 | MAC address of node C | Node B | PA2 |
| VSI 4 | MAC address of node C | Node B | PA2 |
| . . . | . . . | . . . | . . . |

The foregoing descriptions are only examples of the present disclosure and are not for use in limiting the protection scope thereof. Any modification, equivalent replacement and improvement made under the spirit and principle of the present disclosure should be included in the protection scope thereof.

1. A SPB forwarding path control method, comprising:
determining a first SPB node and a neighboring second SPB node are connected via n links by a first SPB node, wherein n is larger than or equal to two;
establishing n different neighborhoods between the first SPB node and the second SPB node through the n links, and saving link state information (LSI) of each of the n links in a local link state database (LSDB) of the first SPB node;
aggregating the LSIs of the n links to an aggregated LSI_{aggr};
distributing the LSI_{aggr} to all of the neighboring SPB nodes, and dropping the LSI_{aggr} distributed from the neighboring SPB nodes; and
calculating a shortest path first (SPF) tree according to the local LSDB by the first SPB node, in which the cost of each link of the n links used for calculating is same, whereby the first SPB node is able to select different links between first SPB node and second SPB node by different ECT algorithms upon determining the forwarding path.

2. A method in accordance with the method of claim 1, wherein after the first SPB node establishes the link with the second SPB node, the determining a first SPB node and a neighboring second SPB node are connected via n links by a first SPB node comprising:
determining the first SPB node and the neighboring second SPB node are connected via the n links when the n links respectively receives Hello messages carrying the same system-ID (SID).

3. A method in accordance with the method of claim 2, wherein the establishing process further comprising:
sending a Hello message to the second SPB node via each link of the n links respectively, and the Hello messages sent to the second SPB node via different links use different SIDs.

4. A method in accordance with the method of claim 3, wherein the SID of the first SPB node carried by the LSI_{aggr} distributed toward each neighboring SPB nodes are the same.

5. A method in accordance with the method of claim 3, wherein the SIDs carried by the Hello messages sent through the n links have a bit-length of X, comprising Y lower-bits and Z higher-bits, and the lower-bits of each SID are the same.

6. A method in accordance with the method of claim 1, further comprising:
saving an identifier of the LSI_{aggr} in an exceptional list; and
receiving the LSI distributed from neighboring SPB nodes, comparing whether the LSI identifier has matched any one of the exceptional list, and dropping the LSI when dropping the LSI_{aggr} distributed from the neighboring SPB nodes.

7. A method in accordance with the method of claim 1, wherein the determining a first SPB node and a neighboring second SPB node are connected via n links by a first SPB node comprising determining whether the first SPB node is connected with the second SPB node via the n links in accordance with predetermined configuration information for a plurality of links.

8. A first shortest path bridging (SPB) node comprising:
a processor and a non-transitory storage medium storing an instruction set executable by the processor to:
determine whether a first SPB node and a neighboring second SPB node are connected via n links, wherein n is larger than or equal to two;
in response to determining that the first SPB node and second SPB node are connected via n links, establish a plurality of different neighborhoods with the second SPB node via each link of the n links, and save link state information (LSI) of each of the n links in a local link state database (LSDB) of the first SPB node;
aggregate the LSIs of the n links to an aggregated LSI_{aggr};
distribute the LSI_{aggr} to all of the neighboring SPB nodes, and drop the LSI_{aggr} distributed from the neighboring SPB nodes; and
calculate a shortest path first (SPF) tree according to the local LSDB, in which the cost of each link of the n links used for calculating is same, whereby to the first SPB node could select different links between first SPB node and second SPB node by different ECT algorithms upon determining the forwarding path.

9. The first SPB node of claim 8, wherein after the first SPB node establishes the link with the second SPB node, the instruction set is further to:
determine the first SPB node and the neighboring second SPB node are connected via the n links when the n links respectively receives Hello messages carrying the same system-ID (SID).

10. The first SPB node of claim 9, wherein the instruction set is further to:
send a Hello message to the second SPB node via each link of the n links respectively, and the Hello messages sent to the second SPB node via different links use different SIDs so as to establish n different neighborhoods between the first SPB node and the second SPB node through the n links.

11. The first SPB node of claim 10, wherein the SID of the first SPB node carried by the LSI_{aggr} distributed toward each neighboring SPB nodes are the same.

12. The first SPB node of claim 10, wherein the SIDs carried by the n Hello message have a bit-length of X, comprising Y lower-bits and Z higher-bits, and the lower-bits of each SID are the same.

13. The first SPB node of claim 8, wherein the instruction set is further to:
save an identifier of the LSI_{aggr} in an exceptional list; and
receive the LSI distributed from neighboring SPB nodes, compare whether the LSI identifier has matched any one of the exceptional list, and drop the LSI when dropping the LSI_{aggr} distributed from the neighboring SPB nodes.

14. The first SPB node of claim 8, wherein the instruction set is further to:
determine whether the first SPB node is connected with the second SPB node via the n links in accordance with predetermined configuration information for a plurality of links.

15. The first SPB node of claim 8, wherein the instruction set is further to:
configure the cost of the n links to be the same, and save the amended cost to the LSDB.
